(19) United States
(12) Patent Application Publication
(10) Pub. No.: US 2002/0110213 A1
(43) Pub. Date: Aug. 15, 2002

(54) Method and apparatus for providing data for sample rate conversion

(75) Inventors: Michael R. May, Austin, TX (US); Carlin D. Cabler, Austin, TX (US)

Correspondence Address: TIM MARKSION, GENERAL COUNSEL, SIGMATEL, INC, 2700 VIA FORTUNA, SUITE 500, AUSTIN, TX, 78746, US

(73) Assignee: Sigma Tel, Inc.

(21) Appl. No.: 09/782,119

(22) Filed: Feb. 13, 2001

(51) Int. Cl. H04L 7/00; H04L 25/00; H04L 25/40

(52) U.S. Cl. 375/372

(57) ABSTRACT

A method and apparatus for providing data for sample rate conversion includes processing that begins by generating a data request interrupt based on a system clock and a sample rate conversion value. The processing continues by receiving a data ready control signal from a data processor. The processing proceeds to responding to the data request interrupt by providing a read signal to a temporary memory device. Based on the read signal, a 1^{st} word of data is read from the temporary memory device and provided to a sample rate conversion module. The processing resumes by responding to the data ready control signal by providing a light signal to the temporary memory device. In accordance with the write signal, a 2^{nd} word of data is written to the temporary memory device by the data processor.

### RELATED PATENT APPLICATIONS

METHOD AND APPARATUS FOR ADJUSTING TIMING IN A DIGITAL SYSTEM having an attorney docket number of SIG000060 and a filing the date the same as the present patent application; and

METHOD AND APPARATUS FOR PROVIDING DOMAIN CONVERSIONS FOR MULTIPLE CHANNELS AND APPLICATIONS THEREOF having an attorney docket number of SIG000059 and a filing the date the same as the present patent application.

### TECHNICAL FIELD OF THE INVENTION

This invention relates generally to telecommunications and more particularly to provided data for sample rate conversion in an analog front-end of telecommunication systems.

### BACKGROUND OF THE INVENTION

As is known, data may be communicated from one entity (e.g. end users, computers, server, facsimile machine et cetera) to another entity via a communication infrastructure. The communication infrastructure may include a public switch telephone network (PSTN), the Internet, wireless communication system, and/or a combination thereof. Such a communication infrastructure supports many data communication protocols, which prescribe the formatting of data for accurate transmission from one entity to another. Such data communication protocols include digital subscriber line (DSL), asymmetrical digital subscriber line (ADSL), universal asymmetrical digital subscriber line (UADSL or G.Lite), high-speed digital subscriber line (HDSL), symmetrical high-speed digital subscriber lines (HDSL), asynchronous transfer mode (ATM), internet protocol (IP), et cetera.

Each of the various data transmission protocols prescribes the formatting of data into frames. Each frame may include a header section, which identifies information particular to the frame, and a data section, which carries the communication data. The data section may be divided into a plurality of data segments, time slots, carrier-frequency bins, packets, et cetera. Depending on the particular data transmission protocol, a frame of data will be transmitted in a continuous manner or in a discontinuous manner. For example, IP and ATM data transmission protocols packetize a frame of data and the packets are transmitted in a discontinuous manner. In contrast, XDSL data transmission protocols require the frames to be transmitted in a continuous manner.

For xDSL data transmission protocols, the data is processed within a modem of a given entity in the digital domain and converted to the analog domain for transmission via the communication infrastructure. Conversely, data is received via the communication infrastructure in the analog domain and converted into the digital domain for further processing. For xDSL modems, the analog to digital conversion and digital to analog conversion are done in an analog front-end. As integration of modem functionality increases, the need for more complex analog front-ends increases accordingly.

Therefore, a need exists for a method and apparatus that provides data for sample rate conversion within an analog front end that supports multiple channels, e.g. telecommunication paths.

### BRIEF DESCRIPTION OF THE DRAWINGS

FIG. 1 illustrates a schematic block diagram of a multi-channel analog front-end in accordance with the present invention;

FIG. 2 illustrates a schematic block diagram of a data providing apparatus in accordance with the present invention;

FIG. 3 illustrates a schematic block diagram of an alternate data providing apparatus in accordance with the present invention;

FIG. 4 illustrates a schematic block diagram of another data providing apparatus in accordance with the present invention; and

FIG. 5 illustrates a logic diagram of a method for providing data for sample rate conversion in accordance with the present invention.

### DETAILED DESCRIPTION OF A PREFERRED EMBODIMENT

Generally, the present invention provides a method and apparatus for providing data for sample rate conversion. Such a method and apparatus includes processing that begins by generating a data request interrupt based on a system clock and a sample rate conversion value. The processing continues by receiving a data ready control signal from a data processor. The processing proceeds to responding to the data request interrupt by providing a read signal to a temporary memory device. Based on the read signal, a 1^{st} word of data is read from the temporary memory device and provided to a sample rate conversion module. The processing resumes by responding to the data ready control signal by providing a light signal to the temporary memory device. In accordance with the write signal, a 2^{nd} word of data is written to the temporary memory device by the data processor. With such a method and apparatus, data is provided to a sample rate converter at rates in accordance with the desired sample rate conversion.

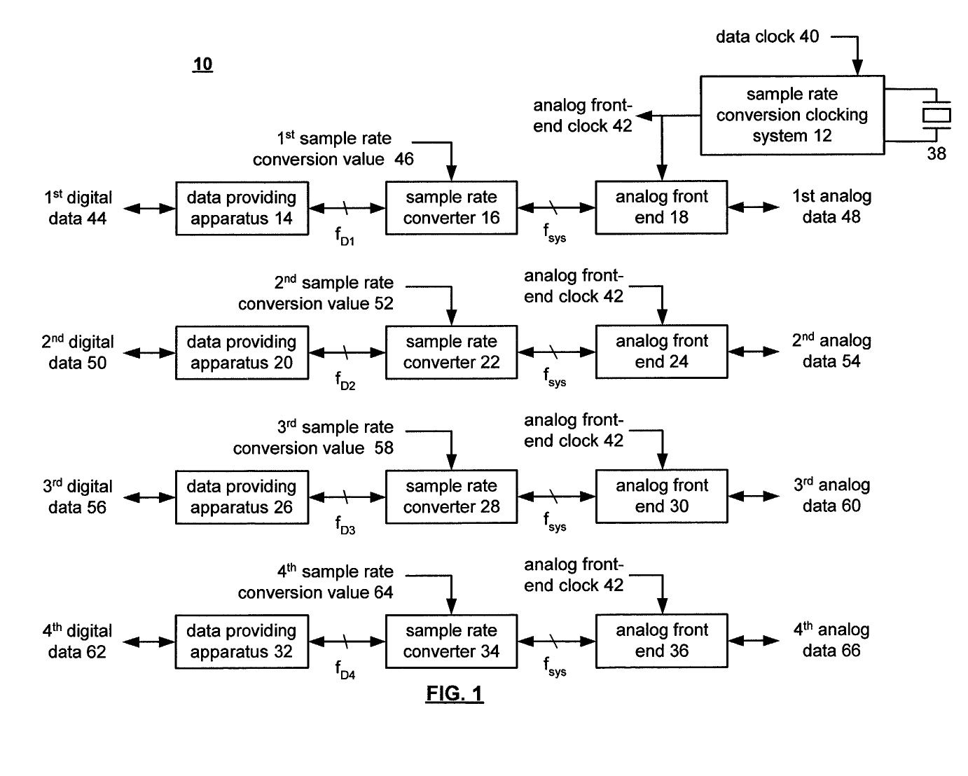

The present invention can be more fully described with reference to FIGS. 1 through 5. FIG. 1 illustrates a schematic block diagram of a multi-channel analog front-end 10. The multi-channel analog front-end 10 includes a sample rate conversion clocking system 12, a plurality of data providing apparatus's 14, 20, 26 and 32, a plurality of sample rate converters 16, 22, 28 and 34, and a plurality of front-end modules 18, 24, 30 and 36. The multi-channel analog front-end 10 supports a plurality of channels (e.g. telecommunication channels, digital system channels, computer data lines, address busses, and/or any transmission path that includes transmission line characteristics.) As such, the multi-channel analog front-end 10 includes a data providing apparatus, sample rate converter, and analog front-end for each channel that it supports. For example, data providing apparatus 14, sample rate converter 16 and analog front-end 18 support a 1^{st} channel. As shown, the analog front-end 18 is operably coupled to receive the 1^{st} digital data 44 at the system clock rate (F_{SYS}) and to produce 1^{st} digital data 48 therefrom. Note that the sample rate conversion, the analog front-end processing, and the selection of the 1^{st} sample rate conversion value 46 is further described in co-pending patent application entitled METHOD AND APPARATUS FOR PROVIDING DOMAIN CONVERSIONS FOR MULTIPLE CHANNELS AND APPLICATIONS THEREOF, having an attorney docket number of SIG000059 and a filing date the same as the filing date for the present application.

The data providing apparatus 14 is operably coupled to receive 1^{st} data 44 at a 1^{st} data rate (F_{D1}) and provides the 1^{st} digital data 44 at the 1^{st} data rate (F_{D1}) to the sample rate converter 16. The sample rate converter 16 based on a 1^{st} sample rate conversion value 46 converts the rate of the 1^{st} data 44 from the 1^{st} data rate (F_{D1}) to a system data rate (F_{SYS}). The system data rate is based on an analog front-end clock 44. Typically, the system clock will be some integer division of the analog front-end clock 42. The determination of the 1^{st} sample rate conversion value 46 and the sample rate conversion performed based on this value is further described in co-pending patent application entitled METHOD AND APPARATUS FOR PROVIDING DOMAIN CONVERSIONS FOR MULTIPLE CHANNELS AND APPLICATIONS THEREOF, having an attorney docket number of SIG000059 and a filing date the same as the filing date for the present application.

A 2^{nd} channel is supported by the data providing apparatus 20, the sample rate converter 22, and the analog front-end 24. The data providing apparatus 20 is operably coupled to receive 2^{nd} data 50 and provide it to the sample rate converter 22 at a 2^{nd} data rate (F_{D2}). Based on a 2^{nd} sample rate conversion value 52, the sample rate converter 22 converts the data rate of the 2^{nd} digital data 50 from the 2^{nd} data rate (F_{D2}) to the system clock rate (F_{SYS}) The analog front-end 24 receives the 2^{nd} digital data 50 at the system clock rate (F_{SYS}) and produces 2^{nd} analog data 54.

A 3^{rd} channel path is supported by data providing apparatus 26, the sample rate converter 28, and the analog front-end 30. The data providing apparatus 26 is operably coupled to receive 3^{rd} digital data 56 and to provide it to the sample rate converter 28 at a 3^{rd} data rate (F_{D3}). The sample rate converter 28 converts the rate or the 3^{rd} digital data 56 from the 3^{rd} data rate (F_{D3}) to the system clock rate (F_{SYS}) based on a 3^{rd} sample rate conversion value 58. The analog front-end 30 receives the sample rate converted 3^{rd} digital data and produces 3^{rd} analog data 60 therefrom.

A 4^{th} channel is supported by the data providing apparatus 32, the sample rate converter 34, and the analog front-end 36. The data providing apparatus 32 is operably coupled to process 4^{th} digital data 62 and to provide or receive the 4^{th} digital data at a 4^{th} data rate (F₄). The sample rate converter 34 converts the sample rate of the 4^{th} digital data 62 between the 4^{th} data rate (F_{D4}) and the system clock rate (F_{SYS}) based on a 4^{th} sample rate conversion value 64. The analog front-end 36 is operably coupled to convert the 4^{th} digital data 62 at the system clock rate to or from 4^{th} analog data 66.

As one of average skill in the art will appreciate, the multi-channel analog front-end 10 may include more or less channel support devices than depicted in FIG. 1. In addition, the processing by the analog front-end 18, 24, 30 and 36 may include a digital to analog conversion process and/or an analog to digital conversion process. Such that data flow may progress from the digital data 44, 50, 56 and 62 to the analog data 48, 54, 60 and 64, or vice versa.

The sample rate conversion clocking system 12 is operably coupled to a crystal 38, a data clock 40 to produce an analog front-end clock 42. The data clock 40 may correspond to the 1^{st} data clock rate (F_{D1}), the 2^{nd} data clock rate (F_{D2}), the 3^{rd} data clock rate (F_{D3}) and/or the 4^{th} data clock rate (F_{D4}). Note that in most telecommunication systems, while the data rates for the 1^{st}, 2^{nd}, 3^{rd} and 4^{th} data 44, 50, 56 and 62 may vary, they will be synchronized and integer multiples or divisions of each other. As such, any one of the clocks may be utilized as the data clock 40 by the sample rate conversion clocking system 12.

The processing performed by the data providing apparatus 14, 20, 26 and 32 is further described in co-pending patent application entitled METHOD AND APPARATUS FOR PROVIDING DATA FOR SAMPLE RATE CONVERSION, having an attorney docket number SIG000063 and a filing date the same as the filing date for the present patent application.

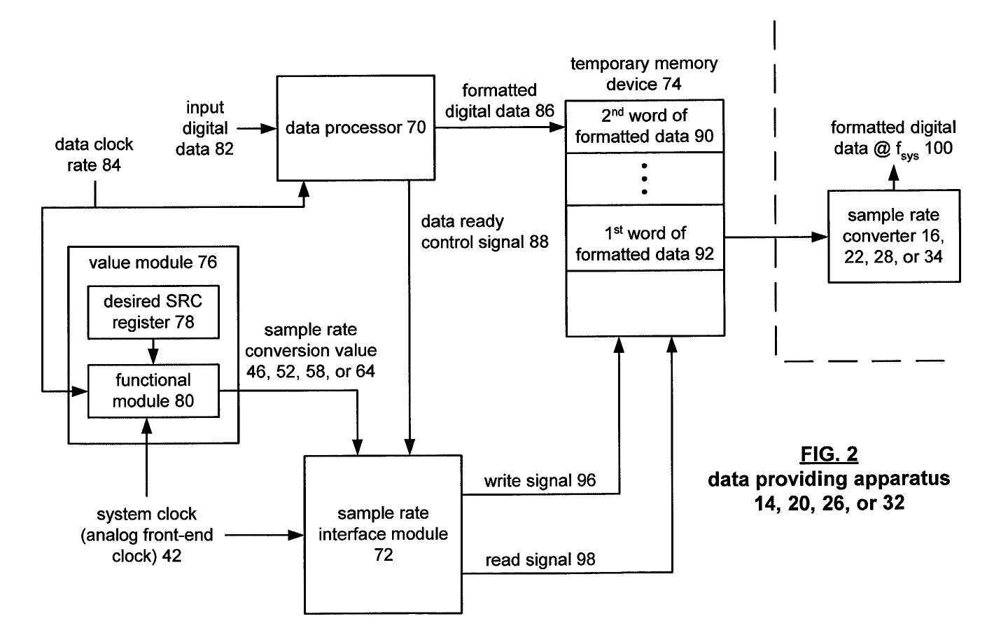

FIG. 2 illustrates a schematic block diagram of a data providing apparatus 14, 20, 26, or 32, which throughout the remainder of the discussion will be referred to as data providing apparatus 14. The data providing apparatus 14 includes a data processor 70, a temporary memory device 74 and a sample rate interface module 72. The data providing apparatus 14 is operably coupled to a sample rate converter 16, 22, 28 or 34. Note that the particular sample rate converter 16, 22, 28 or 34 will depend on which path within the multi-channel analog front-end 10 of FIG. 1 is being referenced. As such, data providing apparatus 14 corresponds to sample rate converter 16, data providing apparatus 20 corresponds to sample rate converter 22 et cetera.

In operation, the data processor 70 is operably recoupled to receive input digital data 82 and produce therefrom formatted digital data 86. The input digital data 82 is representative of data to be transceived with a telecommunication transmission path. The data processor 70, based on a data transport protocol, converts the input digital data 82 into formatted digital data 86. The data transmission protocol may be ADSL, UADSL, HDSL, SHDSL, ATM, IP, and/or any other data transmission protocol that utilizes existing telecommunication infrastructure.

The sample rate interface module 72 is operably coupled to receive a system clock, which may be the analog front-end clock 42, the sample rate conversion value 46, 52, 58 or 64, and a data ready control signal 88. Based on the data ready control signal 88, which is provided by the data processor 70, the sample rate interface module 72 produces a write signal 96. The temporary memory device 74 is operably coupled to receive the write signal 96 and to write a 2^{nd} word 90 of the formatted digital data 86. As such, as the data processor 70 produces formatted digital data 86, which will occur at the data clock rate 84, it produces the data ready control signal 88. Accordingly, the sample rate interface module 72 generates the write signal 96 at a rate approximately equal to the data clock rate 84.

The sample rate interface module 72 based on the sample rate conversion value 46, 52, 58, or 64 and the system clock 42 generates the read signal 98. The read signal 98 is provided to the temporary memory device 74 such that the sample rate converter reads a 1^{st} word 92 of the formatted digital data 86. The sample rate converter then produces formatted digital data at the system clock rate 100.

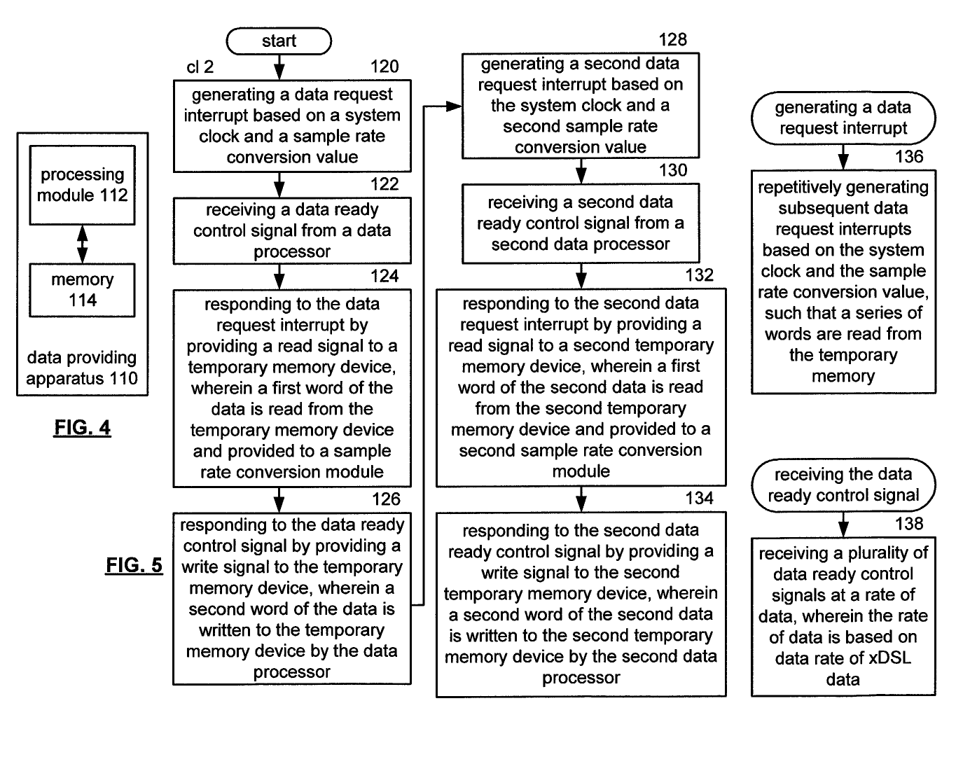

By basing the read signal 98 on the sample rate conversion value and the system clock 42, data is read from the temporary memory device 74 at a rate corresponding to the desired sample rate conversion. Note that the size of the word written into the temporary memory device 74 and read from the memory device 74 may be any bit size. For example, the 1^{st} and 2^{nd} words may be 8 bits, 16 bits, 32 bits, 64 bits et cetera. The data providing apparatus 14 ensures that data is provided to sample rate converter 16, 22, 28, or 34 at a rate corresponding to the sample rate conversion value and the system clock. As such, the temporary memory device 74 may be of a minimal size such that only a few words of the formatted data need to be stored. Accordingly, by reducing the memory size for such a buffer, the overall cost associated with an integrated circuit including the data providing apparatus is reduced. Note that the generation of the read signal 98 and the write signal 96 will be described further with reference to FIG. 4.

The data providing apparatus 14 may further include a value module 76, which includes a desired sample rate conversion register 78 and a functional module 80. The desired sample rate conversion register 78 stores a desired sample rate conversion value. The functional module 80 is operably coupled to receive the data clock rate 84, the desired sample rate conversion value and the system clock 42 to produce the corresponding sample rate conversion values 46, 52, 58 and/or 64. For a more detailed discussion of determining the sample rate conversion values, refer to co-pending patent application entitled METHOD AND APPARATUS FOR PROVIDING DOMAIN CONVERSIONS FOR MULTIPLE CHANNELS AND APPLICATIONS THEREOF, having an attorney docket number of SIG000059 and a filing date as the filing date for the present application.

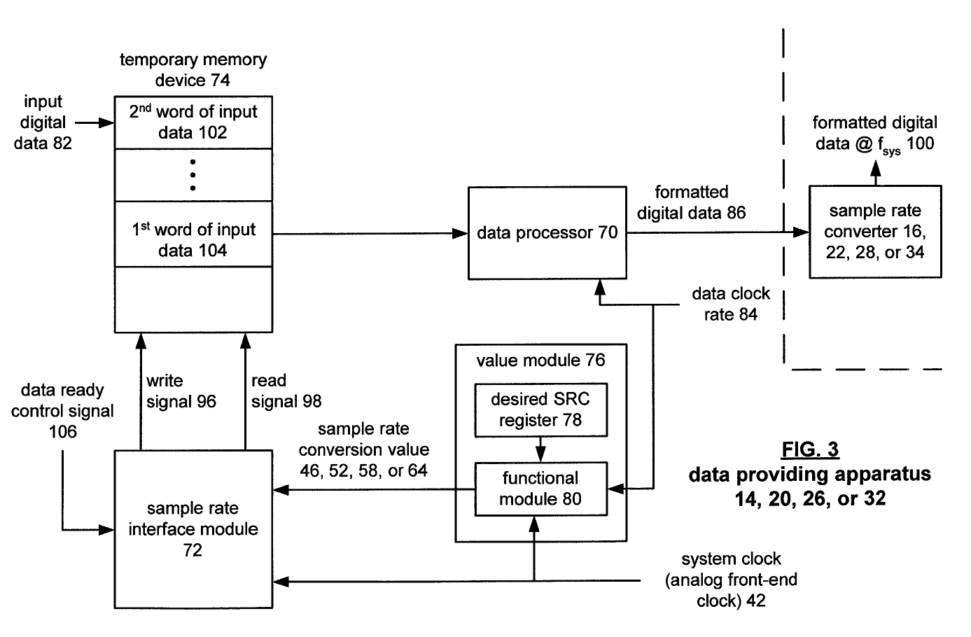

FIG. 3 illustrates a schematic block diagram of an alternate data providing apparatus 14. The data providing apparatus 14 includes the temporary memory device 74, the data processor 70, the sample rate interface module 72 and may further include the value module 76. The data processor 70 is operably coupled to provide formatted digital data 86 to the sample rate converter 16, 22, 28 or 34. The sample rate converter produces the formatted digital data 100 at the system clock rate (F_{SYS}). From this embodiment, the temporary memory device 74 is operably coupled to receive the input digital data 82 and store words of the input data based on the write signal 96. The data processor 70 retrieves the stored words 104 from the temporary memory device 74 based on the read signals 98. The sample rate interface module 72 generates the read signal 98 and the write signal 96 in accordance with the diagram shown in FIG. 4. Note that the temporary memory device 74 may be a random access memory, SRAM, DRAM, a plurality of registers, and/or any device that enables the reading and writing of data therefrom.

FIG. 4 illustrates a schematic block diagram of a data providing apparatus 110 that includes a processing module 112 and memory 114. The processing module 112 may be a single processing device or a plurality of processing devices. Such a processing device may be a microprocessor, microcontroller, digital signal processor, central processing unit, state machine, logic circuitry, and/or any device that manipulates signals (analog or digital) based on operational instructions. The memory 114 may be a single memory device or a plurality of memory devices. Such a memory device may be random access memory, read only memory, floppy disk memory, system memory, flash memory, and/or any device that stores digital information. Note that when the processing module 112 implements 1 or more of its functions via a state machine or logic circuitry, the memory storing the corresponding operational instruction is embedded within the circuitry comprising the state machine or logic circuit. The operational instructions stored in memory 114 and executed by processing module 112 are illustrated in the logic diagram of FIG. 5.

FIG. 5 illustrates a method for providing data for sample rate conversion. The process begins at Step 120 where a data request interrupt is generated based on a system clock and a sample rate conversion value. The sample rate conversion value is determined based on the system clock rate and a data clock rate. The process then proceeds to Step 122 where a data ready control signal is received from a data processor. The process then proceeds to Step 124 where the data request interrupt is responded to by providing a read signal to a temporary memory device. Pursuant to the read signal, a 1^{st} word of data is read from the temporary memory device and provided to a sample rate conversion module.

The process then proceeds to Step 126 where, in response to the data ready control signal, a write signal is provided to the temporary memory device. In accordance with the write signal, a 2^{nd} word of the data is written to the temporary memory device by the data processor. The process then proceeds to Step 128 where a 2^{nd} data request interrupt is generated based on the system clock and the 2^{nd} sample rate conversion value. The process then proceeds to Step 130 where a 2^{nd} data ready control signal is received from a 2^{nd} data processor. The process then proceeds to Step 132 where the 2^{nd} data request interrupt is responded to by providing a read signal to a 2^{nd} temporary memory device. In accordance with the read signal, a 1^{st} word of the 2^{nd} data is read from the 2^{nd} temporary memory device and provided to a 2^{nd} sample rate conversion module. The process then proceeds to Step 134 wherein the2^{nd} data ready control signal is responded to by providing a write signal to the 2^{nd} temporary memory. In accordance with this write signal, a 2^{nd} word of the 2^{nd} data is written to the 2^{nd} temporary memory device by the 2^{nd} data processor.

The generating of a data interrupt request may be further described with reference to Step 136. At Step 136, subsequent data request interrupts are repetitively generated based on the system clock and the sample rate conversion value such that a series of words are read from the temporary memory.

The receiving of the data ready control signal may be further described with reference to Step 138. At Step 138, a plurality of data ready control signals are received at a rate of the data. As such, if the data corresponds to XDSL data the rate will be in accordance with the particular type of DSL data transmission protocol.

The preceding discussion has presented a method and apparatus for providing data for sample rate conversion. As one of average skill in the art will appreciate, other embodiments may be derived from the teachings of the present invention without deviating from the scope of the claims.

What is claimed is:

1. A method for providing data for sample rate conversion, the method comprises the steps of:
generating a data request interrupt based on a system clock and a sample rate conversion value;
receiving a data ready control signal from a data processor;
responding to the data request interrupt by providing a read signal to a temporary memory device, wherein a first word of the data is read from the temporary memory device and provided to a sample rate conversion module; and
responding to the data ready control signal by providing a write signal to the temporary memory device, wherein a second word of the data is written to the temporary memory device by the data processor.

2. The method of claim 1 further comprises:
determining the sample rate conversion value based on the system clock and a data clock.

3. The method of claim 1, wherein the generating a data request interrupt further comprises: repetitively generating subsequent data request interrupts based on the system clock and the sample rate conversion value, such that a series of words are read from the temporary memory.

4. The method of claim 1, wherein the receiving the data ready control signal further comprises:
receiving a plurality of data ready control signals at a rate of data, wherein the rate of data is based on sample rate of xDSL data.

5. The method of claim 1 further comprises:
generating a second data request interrupt based on the system clock and a second sample rate conversion value;
receiving a second data ready control signal from a second data processor;
responding to the second data request interrupt by providing a read signal to a second temporary memory device, wherein a first word of the second data is read from the second temporary memory device and provided to a second sample rate conversion module; and
responding to the second data ready control signal by providing a write signal to the second temporary memory device, wherein a second word of the second data is written to the second temporary memory device by the second data processor.

6. An apparatus for providing data for sample rate conversion, the apparatus comprises:
a data processor operable to receive input data and to produce formatted data at a data clock rate;
temporary memory device; and
sample rate interface module operably coupled to obtain a system clock and a sample rate conversion value and is operably coupled to receive a data ready control signal from the data processor, wherein the sample rate interface module provides a read signal to the temporary memory device such that a first word of formatted data is read from the temporary memory device and provided to a sample rate conversion module, wherein, in response to the data ready control signal, the sample rate interface module provides a write signal to the temporary memory device, wherein a second word of the formatted data is written to the temporary memory device by the data processor, and wherein the read signal is generated based on the system clock and the sample rate conversion value.

7. The apparatus of claim 6 further comprises:
a value module operably coupled to produce the sample rate conversion value based on a function of the system clock and the data clock rate, wherein a resultant of the function is the sample rate conversion value.

8. The apparatus of claim 6 further comprises:
a second data processor operable to receive second input data and to produce second formatted data at a second data clock rate; and
second temporary memory device, wherein the sample rate interface module provides a second read signal to the second temporary memory device such that a first word of second formatted data is read from the second temporary memory device and provided to a second sample rate conversion module, wherein, in response to the second data ready control signal, the sample rate interface module provides a second write signal to the second temporary memory device, wherein a second word of the second formatted data is written to the second temporary memory device by the second data processor.

9. An apparatus for providing data for sample rate conversion, the apparatus comprises:
a data processor operable to receive input data and to produce formatted data at a data clock rate;
temporary memory device; and
sample rate interface module operably coupled to obtain a system clock and a sample rate conversion value, wherein the sample rate interface module provides a read signal to the temporary memory device such that a first word of the input data is read from the temporary memory device and provided to the data processor, wherein the sample rate interface module provides a write signal to the temporary memory device such that a second word of the input data is written to the temporary memory device, wherein the read signal is generated based on the system clock and the sample rate conversion value.

10. The apparatus of claim 9 further comprises:
a value module operably coupled to produce the sample rate conversion value based on a function of the system clock and the data clock rate, wherein a resultant of the function is the sample rate conversion value.

11. An apparatus for providing data for sample rate conversion, the apparatus comprises:
a processing module; and
memory operably coupled to the processing module, wherein the memory includes operational instructions that cause the processing module to:
generate a data request interrupt based on a system clock and a sample rate conversion value;
receive a data ready control signal from a data processor;
respond to the data request interrupt by providing a read signal to a temporary memory device, wherein a first word of the data is read from the temporary memory device and provided to a sample rate conversion module; and
respond to the data ready control signal by providing a write signal to the temporary memory device, wherein a second word of the data is written to the temporary memory device by the data processor.

12. The apparatus of claim 11, wherein the memory further comprises operational instructions that cause the processing module to:
determine the sample rate conversion value based on the system clock and a data clock.

13. The apparatus of claim 11, wherein the memory further comprises operational instructions that cause the processing module to generate a data request interrupt by:
repetitively generating subsequent data request interrupts based on the system clock and the sample rate conversion value, such that a series of words are read from the temporary memory.

14. The apparatus of claim 11, wherein the memory further comprises operational instructions that cause the processing module to receive the data ready control signal by:
receiving a plurality of data ready control signals at a rate of data, wherein the rate of data is based on sample rate of xDSL data.

15. The apparatus of claim 11, wherein the memory further comprises operational instructions that cause the processing module to:
generate a second data request interrupt based on the system clock and a second sample rate conversion value;
receive a second data ready control signal from a second data processor;
respond to the second data request interrupt by providing a read signal to a second temporary memory device, wherein a first word of the second data is read from the second temporary memory device and provided to a second sample rate conversion module; and
respond to the second data ready control signal by providing a write signal to the second temporary memory device, wherein a second word of the second data is written to the second temporary memory device by the second data processor.
